(19) United States
(12) Patent Application Publication
(10) Pub. No.: US 2008/0061737 A1
(43) Pub. Date: Mar. 13, 2008

(54) 5 Half D Cell Battery Pack Charger

(76) Inventor: Gary Michael Johnson, Birmingham, AL (US)

Correspondence Address: Gary M. Johnson, 1005 Pinecliff Circle, Birmingham, AL, 35242, US

(21) Appl. No.: 11/530,532

(22) Filed: Sep. 11, 2006

(51) Int. Cl. H02J 7/00

(52) U.S. Cl. 320/112

(57) ABSTRACT

Battery charging device is reported. The battery charger charges a 5 “half D” cell battery pack found in rechargeable flashlights. Prior, the only way to recharge the battery pack was with it inside the flashlight. By use of end caps to hold the battery pack, wiring, and a cigarette lighter adapter, a 5 “half D” cell battery pack can be charged outside of the flashlight, allowing the use of the flashlight with another battery pack. A resistor regulates current, and a fuse protects the power source. The caps are connected to each other by two elastic bands 180° apart; the elastic provides tension to complete the circuit.

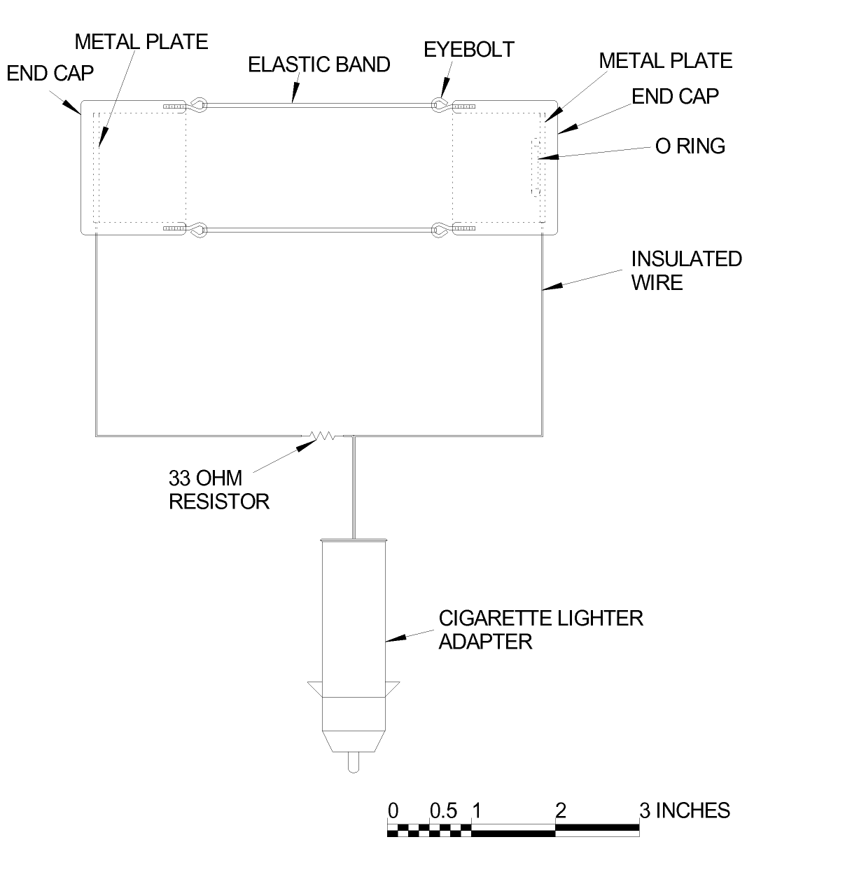

The purpose of this is to recharge a 5 half D cell rechargeable nickel-cadmium battery pack. The battery pack is 6 volts, 2.5 amp-hours, and is commercially available. The half D cells are shrink wrapped together end to end, forming a single unit. The charger consists of two 0.25 inch eye bolts screwed into the lip of the open end of each of two 1.25 inch pvc plastic end caps 180° apart. A 3 inch rubber band connects one eye bolt from each pvc cap to an eye bolt on the opposite end cap. The rubber bands hold the caps against the battery pack from each end. A 1.25 inch diameter metal plate is epoxied inside each cap and is soldered to a wire going through the end of the cap to a cigarette lighter adapter. An “O” ring size AS568A-000-013 (nominal inside diameter of 0.426 inches) is glued to the center of the plate inside the cap that is connected to the positive side of a cigarette lighter adapter. The nipple on the positive end of the battery pack fits inside the “O” ring, and will make contact with the metal plate. If the battery is inserted backwards, the flat side of the battery will contact the “O” ring, and will not complete an electrical circuit. The 33 ohm resistor is installed in the wire going from the negative end of the battery to the negative side of the cigarette lighter adapter. The resistor prevents overheating of the battery by slowing the rate of charge. The caps are connected by 12 inches of dual conductor, 16 gauge insulated wire to the cigarette lighter adapter; it contains an internal, replaceable 250 volt, 5 amp, agu type fuse.

Description of the view of the drawing. The view of the drawing shows a side view with the end caps, wire, and cigarette lighter adapter. The elastic bands hold the end caps against the battery pack while charging. The “O” ring prevents the completion of a circuit if the battery is inserted backwards. The resistor regulates current flow, and a fuse protects from overload in the event of a short circuit. A scale bar is included to show scale.

What is claimed is:

1) A battery pack charging device comprising (a) two end caps, (b) one “O” ring, (c) 2 rubber bands, (d) 2 metal conductors, (e) one resistor, (f) one cigarette lighter adapter with internal fuse, (g) insulated wires specifically for recharging 5 half D cell rechargeable battery packs found in rechargeable flashlights

2) The only current way to recharge these batteries is with them inside the flashlight

3) This allows charging one battery pack while using another inside the flashlight.
